(19) United States
(12) Patent Application Publication
(10) Pub. No.: US 2024/0424824 A1
(43) Pub. Date: Dec. 26, 2024

(54) IMPROVED BINDING SYSTEM FOR FOIL AND AUTOMATIC COUPLING DEVICE

(71) Applicant: Paul GOKKEL, Utrecht (NL)

(72) Inventor: Paul GOKKEL, Utrecht (NL)

(21) Appl. No.: 18/706,157

(22) PCT Filed: Oct. 30, 2022
(86) PCT No.: PCT/IB2022/000645

§ 371 Date: Apr. 30, 2024

(30) Foreign Application Priority Data
Oct. 31, 2021 (NL) 2029572

(51) Int. Cl. B42F 1/00

(52) U.S. Cl. CPC B42F 1/00

(57) ABSTRACT

The present invention relates to a binding system which is especially suitable for firmly joining flexible thin sheets of material together by clamping tabs in recesses. The tabs and recesses can be reinforced on their edges with a plastic strip and are therefore less deformable, so that this system can also be used for joining textiles. The tabs may include a protrusion for better coupling of the sheets. The sheets may include push pads and wedges for use as a hook and loop fastener, a zipper or as a resealable package. Another embodiment concerns a press stud system with two types of metal or plastic press studs, which include either a tab or a recess in the center. The present invention also includes an automatic coupling device. This saves a lot of time in the binding process with larger numbers of tabs to be linked.

The present invention relates to an improvement of the construction system described in Dutch patent application NL 1028365 and the binding system described in Dutch patent application NL 1030759. Both of these patents describe rectangular sheets of paper or other material, which are provided on one edge with a number of tabs and recesses. The recesses have a length, at the level of the edge of the rectangular base sheet, which is equal to the length of the tabs at the height of this edge. This allows these sheets to be attached to each other. These tabs and recesses are punched into the material. This building system can be used to bind thin sheets of material together to form spatial objects and the binding system can be used to stitch single sheets of paper together into a booklet. The number of tabs on the edge(s) of a sheet may vary. A greater number of tabs make the connection more secure. A disadvantage of this bonding method is that the tabs have to be coupled one by one, which is time consuming with larger numbers of tabs.

The French patent FR936384 describes similar tabs, with recesses therebetween, with an oblique edge at the attachment to the base sheet. A disadvantage of this system is that due to the beveled edges of the tabs and the recesses, flexible materials such as textiles cannot be firmly coupled because the tabs deform when little force is applied and the sheets can be pulled loose.

In the present invention, the tabs at both ends of the attachment to the basesheet include a notch substantially parallel to the edge of the basesheet and therefore the tabs are more strongly fixed in the recesses and this system can also be used when joining flexible materials like textiles, rubber films or leather. The present invention also includes an automatic coupling device. This saves a lot of time in the binding process.

The first two patents mentioned describe a construction system with only rectangular sheets. The present invention describes basesheets of material comprising a regular pattern of tabs and recesses at the edges of the basesheet. The base sheet may be a triangular, trapezoidal or arbitrary polygonal surface, but other surfaces are also possible such as compound combinations of rectangles, polygons and trapezoids or slightly curved shapes. As a result, many more three-dimensional surfaces can be built with it.

A preferred embodiment of the invention comprises polygonal building elements each having a fixed length of all ribs and each rib comprising an alternating pattern of tabs and recesses. Alternatively, the lengths of the edges of triangular, trapezoidal, or some other polygonal base sheets may vary. As a result, a regular row of tabs and recesses on an edge is not always feasible with the same position on the edge of the base sheet and/or size of the tabs and recesses. There is then insufficient space on the edge at the ends of the row of tabs and recesses for an extra tab or recess. A different size of the tabs and recesses has the disadvantage that an extra cutting die is required. Instead of a different size of the tabs and recesses, the entire row of tabs and recesses can be shifted along an edge in such a way that it is centered on this edge and the start or end tabs and/or recess fit on the edge. The smaller dimensions of the tabs and recesses simplify this centering of the row of tabs and/or recesses on an edge.

The tabs are preferably (rounded) arrow-shaped and, for a firmer connection, include a notch parallel to the edge of the base sheet at both ends of the attachment of the tab to the base sheet, such that the recesses between the tabs/tabs have a certain height from the edge of the base sheet, which corresponds to the material thickness of the base sheet. Each tab includes a flexible wing on both lateral sides, which may be hingedly attached to the middle portion of the tab. Each tab may include a crease at its attachment to the base sheet such that the tabs may bend around this fold line. By applying such crease lines, sheets with a thicker, more solid base material such as plastic or metal foil can also be linked using this system. The recesses include wings extending maximally up to the center of the recess and may be rounded for smoother attachment of a tab into the corresponding recess of an adjacent sheet. The recesses include two notches on the side of the attachment to the base sheet, substantially parallel to the edge of the base sheet. for more secure coupling of the tabs. The recesses furthermore have a width at the level of the edge of the base sheet which is equal to the width of the tabs at the level of this edge, or possibly a slightly greater length in order to insert the tabs into these recesses more easily. Two edges of adjacent sheets to be joined together, each contain a regular row of either tabs or recesses, or possibly an alternating pattern of tabs and recesses, such that each tab can be attached into the corresponding recess of the edge of the adjacent sheet.

If the material is flexible, such as woven textiles, leather or rubber, etc., the tabs and the edges of the recesses can be reinforced by including an inlay as a plastic strip or a plastic grid to or in the material of the sheet. This can be realised by injection molding plastic on the material of the sheet or by 3D printing plastic on the material of the sheet. This reinforcement strip can also be realized by means of textile treatments such as stitching or embroidery or by means of a sewn/glued reinforcement tape. If the tab is rotated through an angle of 90 degrees or less during the mating process, the tab wings and the corresponding recess wings will interfere with each other and the tab wings and the recess wings cannot bend back to their original flat unfolded position. A preferred embodiment of the present invention therefore comprises tabs that have a bulge in their central part, which protrudes above the material. This improves the coupling process since, during the coupling, the tabs are now rotated through an angle greater than 90 degrees and in this orientation of the tab the wings on both sides of such a tab and the wings of the corresponding recess can unbend back to their original flat position, without interfering with each other.

A variant of the present invention includes two types of snap fasteners, which can be secured in holes at the edge of the base sheet, and include either a tab or a recess. The snap fasteners are preferably located in a long row at some distance from the edge of the base sheet, such that when two base sheets are bonded together, a snap fastener with a tab of one base sheet is always aligned with the corresponding snap fastener with a recess of the other sheet. The snap fasteners are fixed in holes of the base sheet and protrude through the material of the base sheet. The snap fastener is herein riveted to the base sheet by bending the upright rim of the snap fastener on the other side of the base sheet or by clamping it to a complementary washer on the other side of the base sheet. One type of snap fastener comprises a tab in the middle, which is attached flexibly to the edge of this button. The other type of snap fastener comprises a recess in the center with two wings, which are flexibly attached to the edge of this button and leave a recess through which the tab of the first type of snap fastener can be passed.

The present invention also includes a coupling device for faster coupling the tabs of adjacent sheets. This requires a different variant of the tabbed sheets.

In this variant, the edges of the base sheet comprise a rectangular longitudinal guide strip with a regular pattern of recesses, in which the arrow-shaped tabs are embedded.

The corresponding edge of the base sheet, to be coupled with, also comprises a rectangular longitudinal guide strip with recesses, into which the tabs of the first-mentioned base sheet can be fixed.

The recesses in this second guide strip each comprise a similar flexible wing on both sides as the wings of the tabs for firmly attaching the tabs of the first-mentioned base sheet in these recesses of the second base sheet. When both base sheets are placed on top of each other in the correct position for coupling the tabs, teeth of a sprocket wheel of a coupling device can precisely fit into the recesses of the two rectangular longitudinal guide strips and this coupling device can be moved along the edges to be coupled. Also, the tabs and recesses of both sheets to be linked remain precisely aligned along the entire edge.

In an alternative embodiment of the invention, the guide strips of both sheets to be coupled comprise additional guide holes and the sprocket wheel of the coupling device includes additional guide pins, which pass through the guide holes of both sheets.

With this coupling device two sheets bound together can also be released in the same way by first turning over both sheets so that the tabs are on top and then folding over the rectangular longitudinal guide strips of both sheets and feeding them through the coupling device.

A preferred embodiment of the coupling device comprises a holder with a gear wheel comprising special teeth, which push both wings of a tab in the first sheet through the corresponding recess of a second sheet, so that the tab is properly clamped in this recess. The gear of the coupling device can be cylindrical or conical. In this preferred embodiment, each tooth of this gear wheel can comprise two protusions at its end, the function of which is to pull the tab and its wings flat again after it has been pushed through the recess, in such a way that the wings of the tab clamp down the wings of the recess for proper coupling.

The sprocket wheel of the coupling device rotates in this holder, which is also provided with guide slots and preferably also comprises one or more counterwheels and rollers to smoothly guide the sheets to be coupled through the coupling device without friction. In a preferred embodiment, the longitudinal guide strips of both sheets are fed through the bevel gear coupling device in a folded manner so that these guide strips form an acute angle with the superimposed base sheets. As a result, the two longitudinal guide strips with their tabs and the recesses lie closer together, which improves the coupling of the tabs in the recesses and prevents the wings of a tab from inserting uncompletely through the wings of a recess. If the coupling device with the gear is mounted at the end of two superimposed sheets and is moved along the edge of both sheets, the gear will start to rotate as the teeth of the gear engage in the recesses of the sheets and push these special teeth from the sprocket, always push the wings of a subsequent tab of the first sheet through the corresponding recess of a second sheet, so that the tab is properly secured in this recess. The coupling process is complete when both wings of each tab and recess are flattened back to their original flat orientation. In this condition, the tabs can no longer unintentionally come loose from the recesses.

An alternative to the automatic coupling device is the following preferred embodiment of the invention comprising a strip of push pins and a row of tabs each having a protrusion on its central portion. The strip with push pins can be carried out separately in the form of an external coupling device. A preferred embodiment of this external coupling device is a pair of pliers with one or more push pins. The push pin strip lies on top of the sheet with the tabs, which is positioned exactly on the other sheet with the recesses. Pressing the pliers with the push pins strip pushes the tabs of one sheet through the recesses of the other sheet and rotates it through an angle greater than 90 degrees. It is essential that the tabs are precisely aligned over the recesses for proper coupling. This can be achieved by providing both sheets to be linked with a regular pattern of guide holes, such that when the guide holes of the sheets to be linked are aligned with each other, the tabs lie exactly above the recesses. Alternatively the input opening of the pliers can include a common boundary for both guide strips of the sheets to correctly align both guide strips before the coupling.

The guide holes are preferably located in the edges of both sheets to be joined and near the tabs and recesses.

In addition to the push pins, the external coupling device (pliers) herein comprises a separate group of guide pins which already run through the guide holes of both sheets to be coupled before the two sheets are coupled. As a result, both sheets to be coupled are positioned properly before coupling the tabs in the recesses.

The strip with push pins can also be designed as an integral part of one of the sheets to be joined.

There are two variants here:

In the first variant, the push pin strip is hingedly connected to the rectangular longitudinal guide strip with recesses of the one sheet, and is folded over to an acute angle for the coupling process. The other sheet with the tabs is inserted in between and is coupled by pressing the push pin strip.

The second variant includes a push pin strip, which is hingedly connected to the tabbed rectangular longitudinal guide strip of one sheet, and is folded over to an acute angle with the base sheet for the joining process, such that the push pins rest on the bulges of the tabs. The other sheet includes a strip with support wedges, which is hingedly connected to the rectangular longitudinal guide strip with recesses, and is folded over to an acute angle with the base sheet for the joining process, such that the support wedges lie between the recesses on the underside of the base sheet. The support wedges then leave space for the tabs to fold over. Squeezing the push pin strip and support wedge strip couples the sheets. This squeezing can also be realized as a kind of zipper by means of a V-shaped slide, wherein this slide has a narrower V-shaped cross section at the outlet and a wider V-shaped cross section at the inlet.

For precise alignment of the sheets to be coupled, both longitudinal guide strips can comprise a regular pattern of guide holes and guide pins in the vicinity of the tabs and recesses respectively, such that the guide pins of one sheet lie in the guide holes of the other sheet when the tabs are exactly aligned above the recesses. The guide pins protrude on the binding side of a sheet to be coupled and preferably have a rounded surface.

The principle of the invention is demonstrated in the figures:

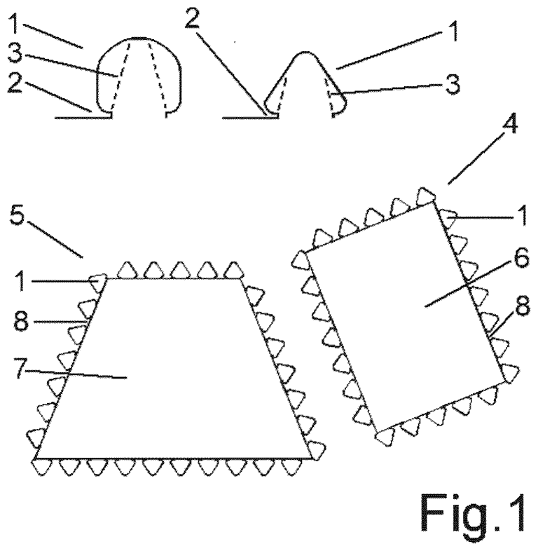

FIG. 1 shows tabs 1, which are known from the construction system described in Dutch patent application NL 1028365 and the binding system described in Dutch patent application NL 1030759.

The top two drawings show the details of these tabs 1. The tabs 1 comprise a central part which on both sides includes a wing hingedly connected to the central part by a bending line 3. The two patents mentioned above only describe rectangular sheets 4. The bottom two drawings in FIG. 1 show a trapezoidal sheet 5 and rectangular sheet 4, of which the edges of the base sheet 7 and the base sheet 6 respectively comprise a regular pattern of tabs 1 and recesses 8. The present invention uses more general polygonal or curved shapes of sheets. Because the edges of these shapes do not have equal lengths, either the position of the entire row of tabs 1 and cutouts 8 will have to shift on the edge so that this row of tabs 1 and cutouts 8 is centered on the edge, or the width of the tabs 1 and recesses 8 on an edge must be adapted to the length of this edge and possibly become larger or smaller Both these adjustments also require an identical adjustment of the tabs 1 and recesses 8 of the corresponding edge to be joined of another sheet for proper coupling of both sheets. The width of a recess 8 should be equal to or slightly larger than the width of the flange of a tab 1 on that same edge.

When attached to the base sheet 6 or 7, the tabs 1 comprise a notch 2 through which they can be snapped into the recesses 8 of the base sheet to be coupled. This notch 2 lies substantially parallel to the edge of the sheet 6 or 7 at the attachment of the flange of the tab 1 for a firmer coupling.

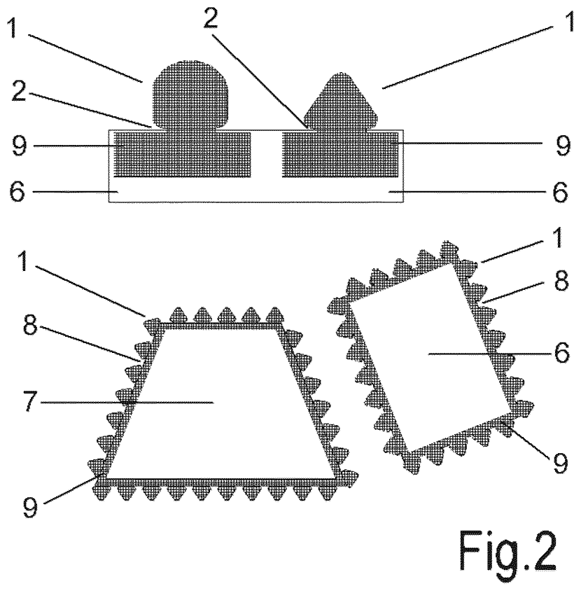

In FIG. 2 the top drawing shows tabs 1 comprising a reinforcement inlay 9 in the form of a plastic strip or a plastic grid or a sewn/glued reinforcement band. As a result, this connection system also works with flexible materials such as textile, rubber, leather or flexible foils and these materials can be firmly connected because the tabs 1 with this reinforcement no longer deform when force is exerted on them. The reinforcement inlay 9 can be designed as separate segments around the tabs 1 as shown in the upper drawing or as a strip 9 encompassing the entire edge of the base sheet 6 and 7, respectively, as shown in the lower two drawings. These base sheets 6 and 7 can therefore be coupled more firmly, but are less flexible.

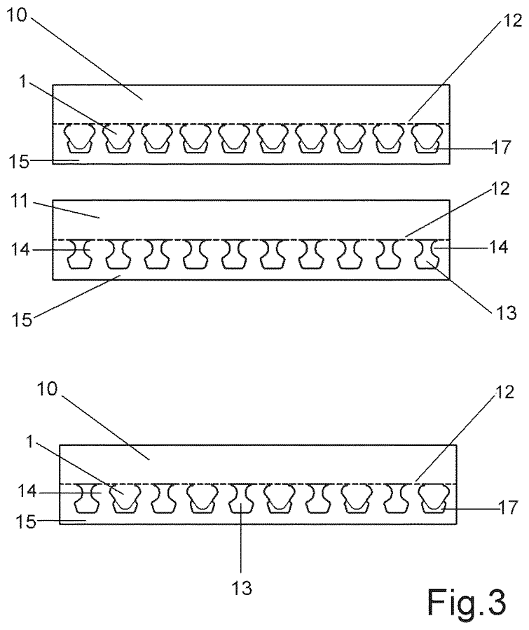

FIG. 3 shows the edges of a base sheet 10, which are provided with only tabs 1 or only recesses 13, or with an alternating row of tabs 1 and recesses 13.

The upper drawing shows an edge of the base sheet 10 with only tabs 1 distributed in a regular row over this edge. These tabs 1 are hingedly connected to the base sheet 10 by means of a folding line 12 and are located in a recess 17 of the material. The recesses 17 leave an edge 15 clear of the material of the base sheet.

The middle drawing shows an edge of the base sheet 11 with only recesses 13 distributed in a regular row over this edge. These recesses 13 include wings 14 and leave an edge 15 free of the material, which is hingedly connected to the base sheet 11 by means of a folding line 12.

The tabs 1 and recesses 13 of these complementary sheets 10 and 11 are in the same position for proper interlocking and the width of the recess 13 near the folding line 12 is at least the width of the flange of a tab 1 at its attachment to the base sheet 10. The openings 13 and 17 at the edges of the base sheets 11 and 10, respectively, have the function of placing the tabs 1 exactly in the correct mutual position with the recesses 13 when these two base sheets are coupled, and to properly position and guide an automatic coupling mechanism. for joining the two sheets. The edge 15 is essential hereby.

The lower drawing in FIG. 3 shows a base sheet 10 which has an alternating row of tabs 1 and recesses 13 on the edge. These tabs 1 are hingedly connected to the base sheet 10 by means of a folding line 12 and are located in a recess 17 of the material. The recesses 13 comprise wings 14 on both sides and leave an edge 15 clear of the material of the base sheet.

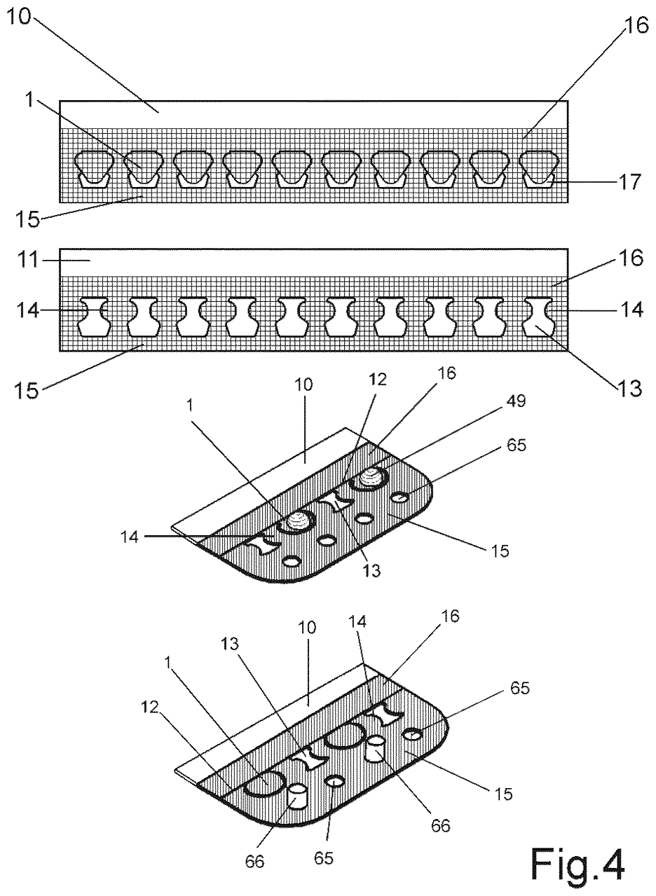

In FIG. 4 the same sheets as in FIG. 3 are described, but now they also comprise a reinforcement inlay 16 on the edge of the base sheet 10 and 11, respectively, in the form of a plastic strip or a plastic grid or a sewn/glued reinforcement tape.

The bottom two images in FIG. 4 show an embodiment of the invention, in which one edge of the base sheet 10 comprises an alternating row of tabs 1 and recesses 13 and the tabs 1 in their central part comprise a (preferably hemispherical) bulge 49. This bulge 49 stiffens the tab 1 and reduces stretching of the bonded sheets. Also, this protrusion 49 improves the folding of the tab 1 over more than 90 degrees during the coupling process.

In the lower two images of FIG. 4, the edges 15 include guide holes 65.

If an external coupling device (pliers) is used for pushing the tabs 1 into the recesses 13, guide pins of that coupling device can fall through the guide holes 65 of both sheets 10 to be coupled even before the coupling of the two sheets. As a result, both sheets 10, to be coupled, are well positioned for coupling the tabs 1 in the recesses 13.

The lowest image in FIG. 4 shows an alternative configuration of a sheet 10, which has a regularly alternating row of both guide holes 65 and guide pins 66, fitting therein, residing in the rim 15. The top of the one base sheet 10 comes to lie on the same top of the flipped second base sheet 10 with the guide pins 66 of the one sheet 10 in the guide holes 65 of the second base sheet 10. These two sheets 10 are thus immediately well positioned for coupling.

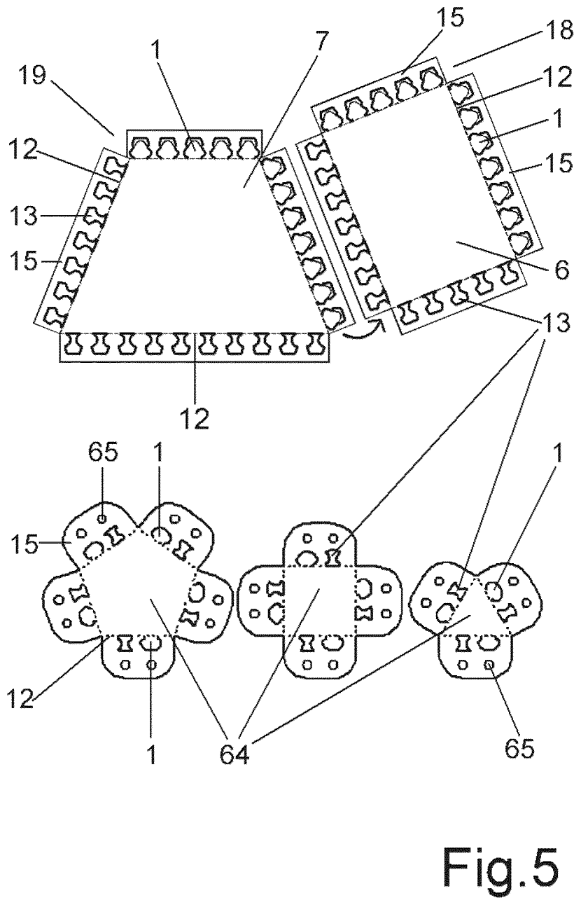

FIG. 5 shows the coupling method of a trapezoidal sheet of material 19 to a rectangular sheet 18. The trapezoidal sheet of material 19 comprises a trapezoidal base sheet 7 having on the right edge and on the top edge a strip with only tabs 1 and on the left edge 15 and on the bottom edge a strip with only recesses 13. All the above strips are bendable with respect to the base sheet 7 by means of a folding line 12. The right oblique edge of sheet 19 comprises a strip with tabs 1, which are clamped in the recesses 13 of the left edge of the sheet 18. The rectangular sheet of material 18 comprises a rectangular base sheet 6 with on the right edge and on the top edge a strip 15 with only tabs 1 and on the left edge and on the bottom edge a strip with only recesses 13.

All the above-mentioned strips 15 are bendable with respect to the base sheet 6 and 7, respectively, by means of a folding line 12.

When the two sheets are joined, the tabs 1 of the strip on the right oblique edge of sheet 19 are clamped into the recesses 13 of the strip on the left edge of sheet 18.

Afterwards, other sheets can be attached to this combination in the same way. By always designing all sheets with the strips with tabs 1 on fixed edges (in this figure the top edges and right side edges) and the strips with recesses 13 also on fixed edges (in this figure the bottom edges and left side edges), this is successively linking works well.

The bottom three images of FIG. 5 show an alternative embodiment of the present invention comprising polygonal building elements with a fixed rib length. The base sheet 64 has a polygonal shape with ribs that may include an edge 15 with both a tab 1 and a recess 13. The rim 15 is hingedly connected to the polygonal base sheet 64 with a crease line 12 and also includes two guide holes 65 for a precise mutual positioning during the coupling process.

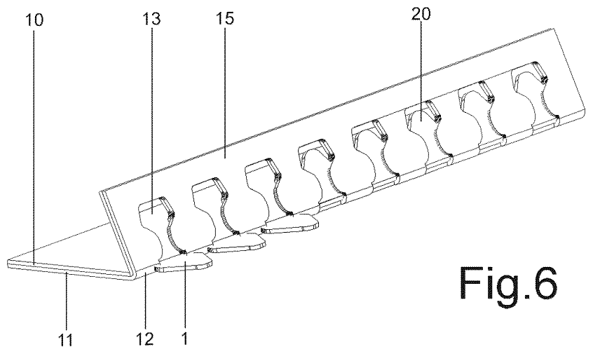

FIG. 6 shows a possible configuration for the position of the edges of two sheets to be coupled during the joining process.

The sheet 10 with uncoupled tabs 20 lies on top of a sheet 11 with cutouts 13. Both sheets are bent about the folding line 12 such that at the edge of both sheets the strips with the tabs and cutouts form an acute angle with the base sheets 10 and 11. This sharp angle facilitates the coupling process by pressing the material of the sheets together more firmly at the level of the tabs and recesses. On the right an unclamped tab 20 of the top base sheet 10 is shown and on the left a tab 1 of the top base sheet 10 is clamped into a recess 13 of the bottom base sheet 11. The edge 15 of the sheets acts as a reinforcement.

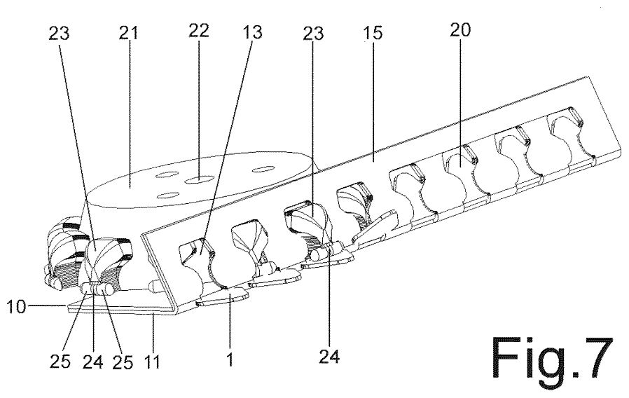

FIG. 7 shows the same sheets 10 and 11 as in FIG. 6 on which the coupling gear 21 is mounted. This coupling gear 21 is part of a coupling device which will be explained below and rotates therein about a shaft with a shaft hole 22. The coupling gear 21 has a number of projections 23 on its lower edge, which protrude through the holes 13 of the sheets 10 and 11 to be coupled.

By sliding the coupling device with the coupling gear 21 along this edge, this coupling gear 21 will rotate like a gear on a rack, because these protrusions 23 are pushed through the recesses 13.

The cylindrical projections 25 first push one wing of a tab 1 through the recess 13 and afterwards push the second wing of the same tab 1 through the recess 13, simultaneously spreading both wings of the tab 1 by both projections 25 of the projection 23. This spreading of both wings of a tab 1 is necessary to prevent the tab 1 from becoming detached from the recess 13 after the tab 1 has been coupled into a recess 13. The third tab from the left in FIG. 7 shows this spreading process of a tab 1 through both protrusions 25, which extend at the ends of the central part 24 at the bottom of a protrusion 23.

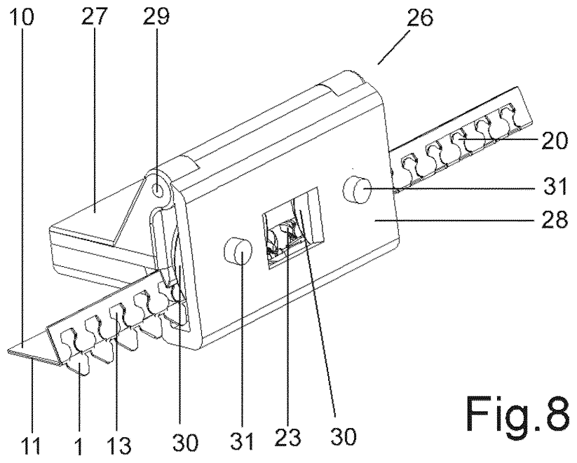

FIGS. 8, 9 and 10 show a coupling device 26 for more quickly coupling the tabs of adjacent sheets. The coupling device 26 comprises a holder with a coupling gear 21, which in this preferred embodiment comprises two parts 27 and 28 which are rotatably connected by a shaft 29. One part 27 comprises the coupling gear 21 and the other part 28 of the holder comprises two conical guide wheels. 30, which are rotatably mounted on shafts 31 on this part 28.

FIG. 8 shows an oblique view of this coupling device 26 in the closed position with the folded base sheets 10 and 11 clamped between the parts 27 and 28 of the coupling device 26. The parts 27 and 28 of the coupling device 26 here leave an opening free in such a way that the folded base sheets 10 and 11 can slide smoothly through this opening. The tabs 20 of the superimposed folded base sheets 10 and 11 on the right side of the coupling device 26 in this figure are not yet joined and The tabs 1 of the superimposed folded basic sheets 10 and 11 on the left side of the coupling device 26 in this image are already linked.

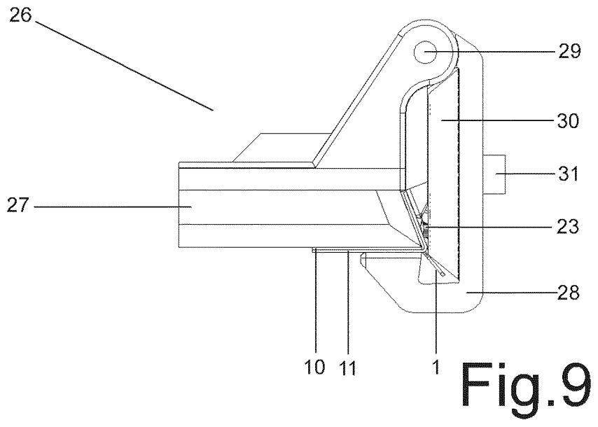

FIG. 9 shows a side view of this coupling device 26 in the closed position with the folded base sheets 10 and 11 clamped between the parts 27 and 28 of the coupling device 26. The parts 27 and 28 of the coupling device 26 here leave an opening such that the folded base sheets 10 and 11 can slide smoothly through this opening. In this figure there is a side view of one of the two conical guide wheels 30, which are rotatably mounted to the part 28 of the coupling device 26 by means of shafts 31.

Each protrusion 23 of the coupling gear 21 comprises a central part 24 on its underside with a preferably cylindrical protrusion 25 at both ends.

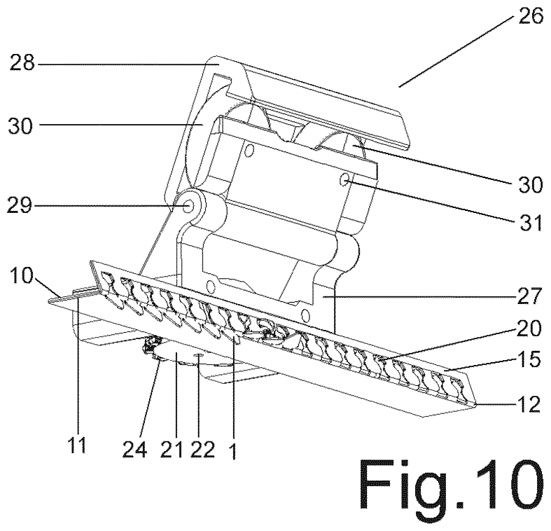

These conical guide wheels 30 guide the folded base sheets 10 and 11 through the coupling device with as little friction as possible. During the coupling of the folded base sheets 10 and 11, the coupling gear 21, which is located in the left part 27 (not visible in this FIG. 9, see FIG. 10), pushes the folded base sheets 10 and 11 to the right, and they become detached from the part 27. This can disrupt the coupling process and is prevented by protruding the upper edge of the conical guide wheels 30 such that this upper edge extends a short distance below the lower sheet 11. FIG. 9 also shows a tab 1 which is folded over even further by the upper edge of the conical guide wheel 30 and thereby ensures a better attachment.

FIG. 10 shows an oblique view of this coupling device 26 in the open position. The unfolded upper part 28 of the coupling device 26 comprises two conical guide wheels 30, which are rotatably mounted on the part 28 of the coupling device 26 by means of shafts 31. The upper part 28 of the coupling device 26 is pivotally connected by means of a shaft 29. with the lower part 27 of the coupling device 26. Mounted on the lower part 27 is the coupling gear 21 which can rotate in this part 27 about a shaft 22. Also in FIG. 10 the central parts 24 are shown located at the lower edge of the protrusions 23 (FIG. 7). with the cylindrical protrusions 25 at both ends of the central part 24 (FIG. 7) For coupling the base sheets, the upper part 28 of the coupling device 26 should be folded down and fixed to the lower part 27.

The shafts 31 of the conical guide wheels 30 can pass through a screw connection or locking pin at their ends to give the function of securing this part 28 to the part 27 of the coupling device 26.

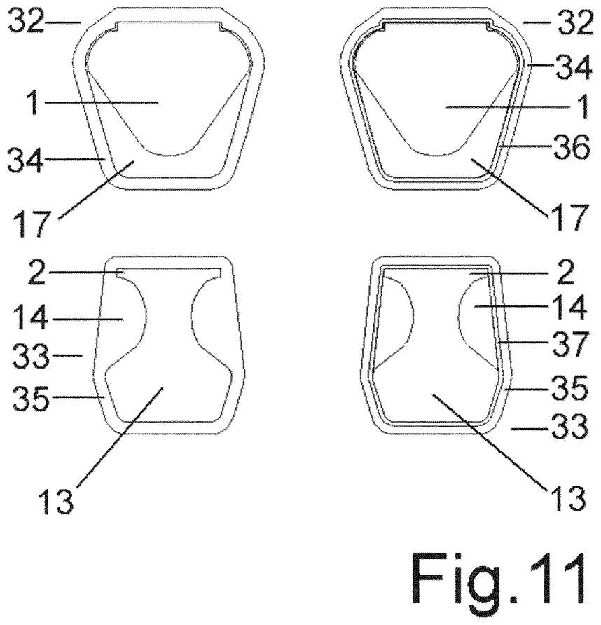

FIG. 11 shows the top (left drawings) and bottom (right drawings) view of another preferred embodiment of the present invention. This relates to a press stud system according to the same principle, comprising two complementary press studs 32 and 33.

The upper left drawing in FIG. 11 shows the top view of a press stud 32 comprising a tab 1, which is flexibly mounted on a ring 34 and leaves an opening 17 free within this ring 34. The drawing at the top right of FIG. 11 shows the bottom view of the same press stud 32. This press stud 32 has a raised rim 36 on its underside.

The drawing at the bottom left of FIG. 11 shows the top view of the second complementary type of snap fastener 33 which includes a recess 13 in a ring 35 and two flexible wings 14. The wings 14 of the recess 13 leave notches 2 in which the tab 1 of the complementary snap fastener 32 can be clamped.

The drawing at the bottom right in FIG. 11 shows the bottom view of the same press stud 33. This press stud 33 comprises a raised rim 37 on its underside.

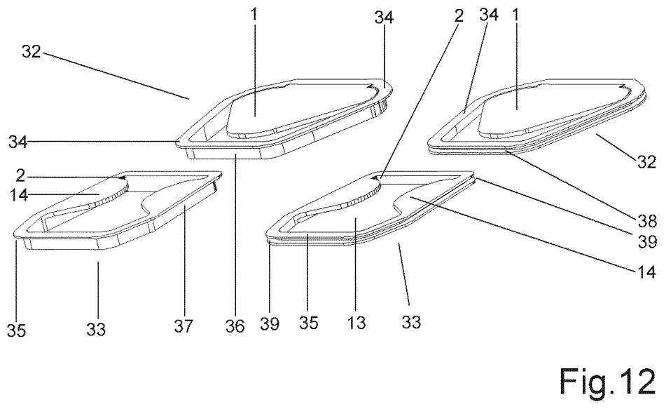

FIG. 12 shows an oblique view of the same complementary snaps 32 and 33. The left images show the original complementary snaps 32 and 33.

These can be placed in punched holes in a thin sheet of material or foil and then the raised edge 36 of the press stud 32 can be pressed wider out and the raised edge 37 of the press stud 33 can be pressed wider out, in such a way that both press studs are firmly attached and anchored to the thin sheet of material or foil. A cavity 38 is created in the riveted snap fastener 32, in which the sheet of material or foil is firmly fixed, and the riveted snap fastener 33 creates a similar cavity 39, in which the sheet of material or foil is firmly fixed.

In the case of fragile materials such as textiles, for example, a closing ring (washer) can be inserted, which comprises a recess, into which the upright edge 36 of the press stud 32 and the upright edge 37 of the press stud 33 can be fit for a more durable coupling. An alternative fastening method for the snap fasteners 32 and 33 and the associated washers can be done by means of (ultrasonic or high-frequency) welding of the snap fastener to the thin material or foil and/or the washer underlying it.

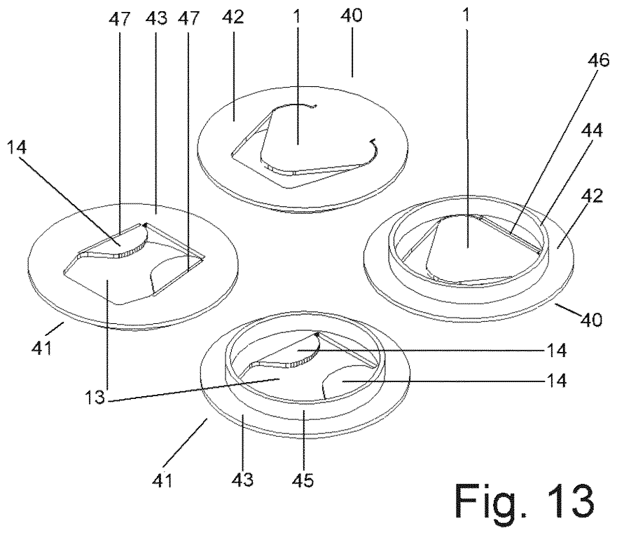

FIG. 13 shows an oblique view of a variant of these snaps with two complementary snaps 40 and 41. The left images show a top view of two complementary snaps 40 and 41 and the right images show a bottom view of the two snaps 40 and 41. The press stud 40 comprises a tab 1 which is flexibly mounted on a ring 42 by means of a film hinge 46. This press stud 40 includes a raised rim 44 on its underside.

The second complementary type of snap fastener 41 comprises a recess 13 in a ring 43 including two flexible wings 14, which are flexibly mounted on the ring 43 by means of a film hinges 47. This snap fastener 41 has a raised rim 45 on its underside. Both snap fasteners 40 and 41 can be placed in punched round holes in a thin sheet of material or foil and then the raised rim 44 of the snap fastener 40 can be pressed outwards and the raised rim 45 of the snap fastener 41 can be pressed outwards, in such a way that both press studs are firmly anchored to the thin sheet of material or foil.

In the case of fragile materials such as textiles, for example, a round washer can be inserted here, which has a round hole, into which the upright rim 44 of the press stud 40 and the upright rim 45 of the press stud 41 fit tight.

An alternative fastening method for the snap fasteners 40 and 41 and the associated washers can be done by means of (ultrasonic or high-frequency) welding of the snap fastener to the thin material or foil and/or the washer underlying it.

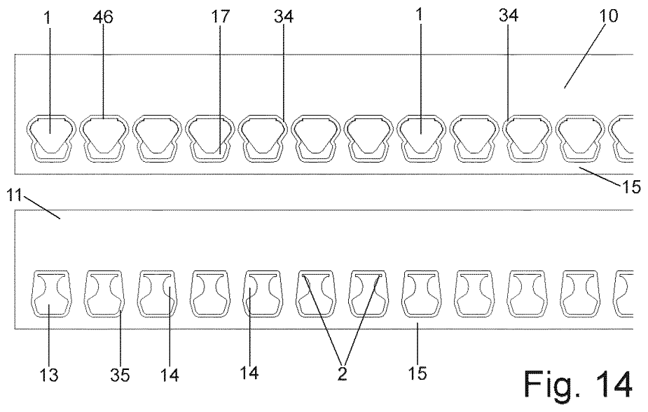

FIG. 14 shows the positioning of the complementary snaps which have an analogous geometry and the same functionality as the positioning of the tabs and recesses of FIGS. 3 and 4.

The upper drawing shows an edge of the base sheet 10 with press studs with only tabs 1 distributed in a regular row along this edge. These tabs 1 are hingedly connected to the press stud in the base sheet 10 by means of bend lines 46 and are located in recesses 17 of the press stud. The edge 34 of the press stud reinforces the edge of the recess 17. The recesses 17 leave a strip 15 free of the material of the base sheet 10.

The lower drawing shows an edge of the base sheet 11 with press studs with only recesses 13 distributed in a regular row along this edge. These recesses 13 of the press studs comprise wings 14.

The wings 14 of the recess 13 include notches 2 at the binding site in which the tab 1 of the complementary snap fastener 32 can be clamped.

The edge 35 of the press stud reinforces the edge of the recess 13. The recesses 13 leave a strip 15 free of the material of the base sheet 11.

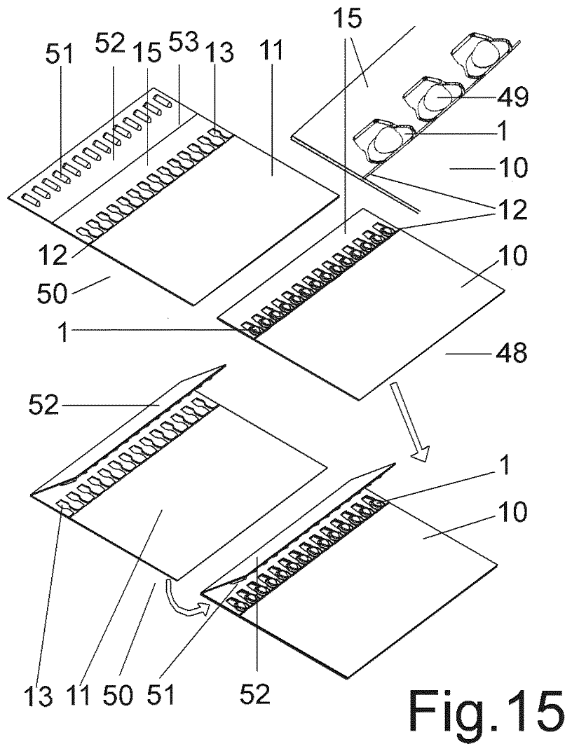

FIG. 15 shows another preferred embodiment of the present invention, in which the tabs 1 include a bulge or bump 49 at their central portion, which leaves space on either side for the flexible wings of the tab.

The top left image in FIG. 15 shows a sheet 50 with push blocks 51 embedded in a push block strip 52 hingedly connected by a fold line or film hinge 53 to the rectangular longitudinal guide strip 15 with recesses 13 of the sheet 50. The rectangular longitudinal guide strip 15 is hingedly connected to the base sheet 11 by means of a fold line or film hinge 12.

The top right image shows a detail view of the complementary sheet 48, which is completely shown immediately below this detail view. This complementary sheet 48 comprises at the edge a strip 15 provided with tabs 1, which have a bulge 49. The tabbed strip 15 is hingedly connected to the base sheet 10 by a fold line or film hinge 12.

The lower left image in FIG. 15 shows how the push block strip 52 of the sheet 50 is folded over to an acute angle with respect to the base sheet 11 for the joining process. The lower right image in FIG. 15 shows the manner in which the sheet 48 with the tabs 1, is slid into the folded sheet 50 so that each tab 1 of sheet 48 is positioned exactly above a corresponding recess 13 of sheet 50.

By manually pressing the push block strip 52 of the sheet 50, the push blocks 51 move downwards and press on the protrusions 49 of the tabs 1. As a result, the tabs 1 move downwards through the underlying recesses 13 of sheet 50. The tabs 1 hereby rotate over an angle greater than 90 degrees, and as a result the wings of the tabs 1 and recesses 13 spring back flat again and both sheets 48 and 50 are firmly connected.

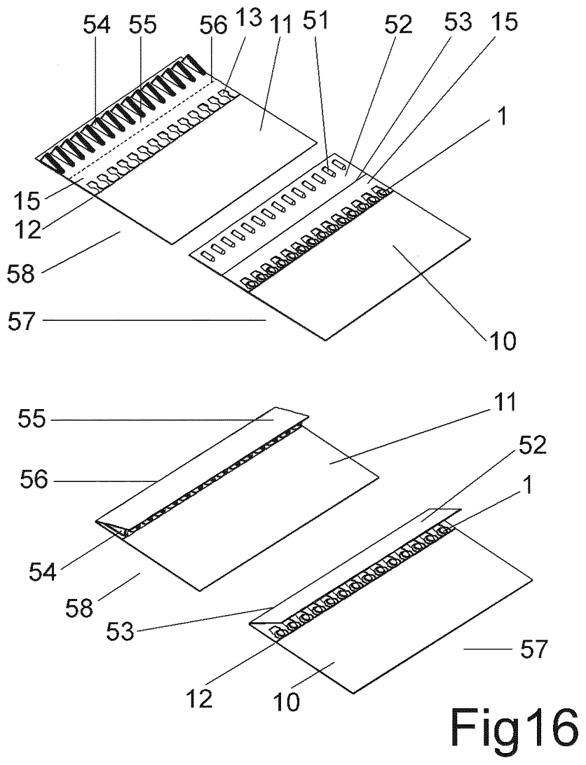

FIG. 16 shows the second version of this principle, comprising a sheet 57 with a push block strip 52, hingedly connected to the rectangular longitudinal guide strip 15 with tabs 1, and another sheet 58 comprising a supporting wedge strip 55, hingedly connected to the rectangular longitudinal guide strip 15 with recesses 13. The upper left image in FIG. 16 shows a sheet 58 with support wedges 54 embedded in a support wedge strip 55 hingedly connected by a fold line or film hinge 56 to the rectangular longitudinal guide strip 15 with recesses 13 of the sheet 58.

The rectangular longitudinal guide strip 15 is hingedly connected to the base sheet 11 by means of a fold line or film hinge 12. The top right image shows the complementary sheet 57. This complementary sheet 57 comprises at the edge a row of pushing blocks 51, embedded in a push block strip 52, which is hingedly connected by means of a folding line or film hinge 53 to the rectangular longitudinal guide strip 15 provided with tabs 1, which have a bulge 49. The strip 15 of tabs 1 is hingedly connected to the base sheet 10 by means of a fold line or film hinge 12.

The illustration at the bottom right of FIG. 16 shows how the push block strip 52 is folded over about the fold line 53 until it forms an acute angle with the base sheet 10 of sheet 57.

The image at the lower left of FIG. 16 shows how the supporting wedge strip 55 with supporting wedges 54 is folded over to an acute angle with the base sheet 11 of sheet 58 for the coupling process, such that the supporting wedges 54 lie between the recesses 13 on the base sheet 11. The support wedges 54 then leave space for the tabs 1 to fold through. Sheet 57 is turned 180 degrees before coupling and placed under sheet 58. The sheets 57 and 58 can preferably be provided with guide holes 65 and guide pins 66 in the longitudinal guide strips 15 for optimum mutual positioning during the coupling process, as shown in the lower image in FIG. 4.

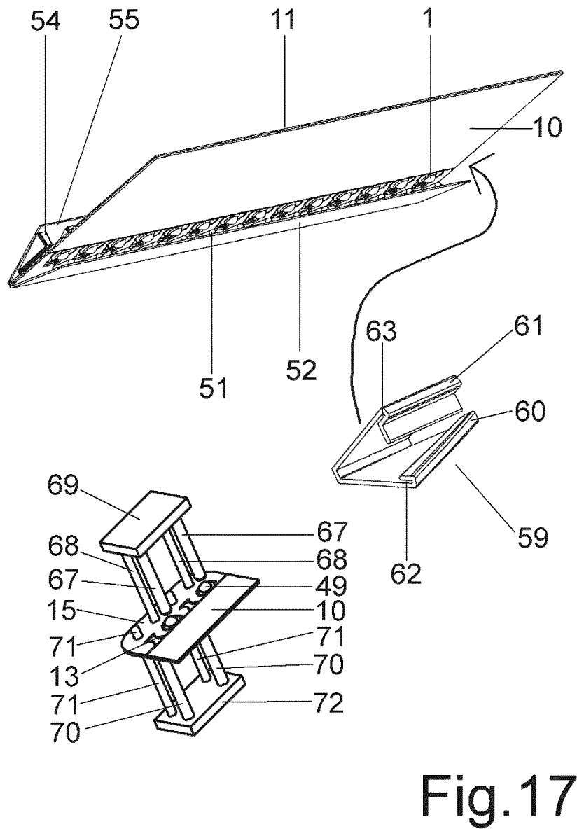

FIG. 17 shows how the sheets 57 and 58 lie against each other before coupling. By squeezing the push block strip 52 and support wedge strip 55, the push blocks 51 push the tabs 1 through the recesses 13 and the sheets 57 and 58 are coupled. This pinching can be done manually or by moving a V-shaped slide along the edge of the sheets, which pushes the folded strip 52 with the push blocks 51 and the folded strip 55 with the supporting wedges 54 together. The middle image in FIG. 17 shows this slide 59. This slide 59 has a wider V-shape on the input side of the strips 52 and 55 than on the output side of the coupled sheets. At the entry of the slide 59, the support wedge strip 55 of the sheet slides through the opening 63 and the push block strip 52 slides through the opening 62. At the narrower exit of the slide 59, the support wedge strip 55 of the sheet slides through the opening 61 and the push block strip 52 through the opening 60 and the two sheets 57 and 58 are coupled.

The lower image in FIG. 17 shows an external coupling device in the form of a beak of a pair of pliers coupling two tabbed sheets 10 as shown in the second lowest image in FIG. 4. The upper part of the external coupling device comprises a block 69 with a number of push pins 67 resting on the protrusions 49 of the tabs and a number of guide pins 68 which slide through the guide holes 65 (see FIG. 4) of both strips 15 of the sheets 10. The lower part of the external coupling device comprises a block 72 with a number of push pins 70 resting on the tabs of the bottom sheet and a number of guide pins 71 which slide through the guide holes 65 (see FIG. 4) of both sheets. When both blocks 69 and 72 are compressed, the push pins 67 and 70 push all the tabs through the recesses 13. For an extra alignment of these sheets 10 for the coupling, the external coupling device can include a entry opening which fits tightly the common boundaries of the strips 15 of the sheets 10.

The present invention can well be used as modular clothing with different sizes of fabric that can be linked together, which are assembled into a well-fitting garment. If the clothing is too tight or too loose, a strip of fabric can be replaced by a wider or narrower strip of fabric, respectively. A broken part of the clothing can easily be replaced with this system without using a sewing machine. Applications in furniture upholstery and shoe manufacturing with modular footwear are also possible. By providing parts of the shoe, such as the upper and the sole, with tabs and recesses, these parts can be easily exchanged or replaced. The system of tabbed sheets with an attached strip with push blocks and recessed sheets with an attached strip with wedges, of the present invention can also be used as a zipper or hook-and-loop fastener. If a hook-and-loop fastener is designed according to this system, this hook-and-loop fastener can only be closed after pushing both parts together so this hook-and-loop fastener can no longer adhere unintentionally prematurely. The system of sheets with tabs, which are provided with protrusions, and with an attached strip provided with push blocks and sheets with recesses with an attached strip provided with wedges, can also be used as resealable packaging.

It will be clear to those skilled in the art that the inventive idea allows for a wide application and is certainly not limited to the examples given, which only serve as an illustration.

1-13. (canceled)

14. Sheets of thin material or foil, comprising one or more edges with a row of tabs, each including one or more wings, and/or recesses, each including one or more wings, characterized in that the recesses leave free a minimum distance to the outer edge of the sheet of material or foil and the tabs at their base are flexibly connected by a flexible flange to the sheet of material or foil and the tabs are positioned in separate recesses of the sheet of material or foil, which also leave free a minimum distance to the outer edge of the sheet of material or foil, with a mutual positioning of the tabs and recesses within sheets of material or foil to be coupled, that the tabs of the one sheet can be inserted and fixed in corresponding recesses of the other sheet.

15. Sheets according to claim 14 characterized by that the recesses and tabs at the binding edge of the sheet a hump in their central portion, which protrudes above the material, allowing a tab to fold over an angle greater than 90 degrees when being coupled.

16. Die-cut shape or laser cutting model characterized in that it can punch a row of holes in thin sheets or foils that either include a tab with one or two wings in the hole or create a recess that includes one or two wings in the material and a minimum fixed distance is left free between all holes and the outer edge of the sheet, as described in claim 14.

17. Coupling device for automatically joining two or more sheets of thin material or foil from the preceding claims, characterized in that this device is guided from one end to the other end of the common edge of both sheets by one or more guide wheels, gears or rollers, such that the gears engage in the common recesses of both superimposed sheets and these gears comprise a plurality of radially oriented projections which successively push the wings of a tab on one sheet through the recess of the sheet to be joined.

18. Sheets of thin material or foil according to claim 15, characterized in that one type of sheet comprises a strip with a row of pushing blocks, and this strip is hingedly connected to the edge of the sheet and these pushing blocks can be positioned on top of the tabs by folding over the strip with the row of push blocks and a second, to be coupled to said first type of, sheet, comprises a strip with a row of supporting wedges and this strip is hingedly connected to the edge of the second type of sheet and by folding the strip with the row of support wedges at an acute angle to the rest of the sheet these support wedges rest on the underside of the sheet with the row of recesses and the support wedges being positioned between these recesses allowing a smooth coupling of the tabs of one sheet into the recesses of the other sheet.

19. A sliding block, characterized in that it can move along the edges of the sheets of claim 18 and includes a V-shaped opening that is wider on the input side and more sharply angled on the output side to form a narrower V-shaped opening for compression of the strip with push blocks and the strip with supporting wedges, mentioned in claim 18, causing the tabs of one sheet being pressed through the recesses of the other sheet to couple both sheets.
